(19) United States
(12) Patent Application Publication
(10) Pub. No.: US 2007/0130509 A1
(43) Pub. Date: Jun. 7, 2007

(54) Custom publication rendering method and system

(75) Inventors: Barry G. Gombert, Rochester, NY (US); Lisa Sniedze Purvis, Fairport, NY (US)

Correspondence Address: PEPPER HAMILTON LLP, ONE MELLON CENTER, 50TH FLOOR, 500 GRANT STREET, PITTSBURGH, PA, 15219, US

(73) Assignee: Xerox Corporation

(21) Appl. No.: 11/294,325

(22) Filed: Dec. 5, 2005

(51) Int. Cl. G06F 17/00; G06F 17/30

(52) U.S. Cl. 715/513; 707/1; 715/751; 707/3

(57) ABSTRACT

A method and system renders a custom document by providing an interactive electronic portal that allows multiple users to communicate with each other via any number of communication types. The system selects content from the communications and stores the content in a content repository. When the system receives a request to retrieve selected content items from the repository, it assembles the selected content items into a structured document for publishing via a rendering device.

### TECHNICAL FIELD

The present disclosure relates to data-processing methods and systems. More particularly, the present disclosure relates to authoring, communicating, printing, and/or publishing methods and systems offered via computer networks and electronic portals.

### DESCRIPTION OF THE RELATED ART

Digital imaging technology has transformed the production printing industry by enabling new markets and business opportunities. Some publishing and printing systems are capable of producing millions of pages per month. The use of digital production printing systems to produce printed materials for coursework, customized forms, and detailed paper based reports has been commonplace.

In response to these technological changes, industry vendors are adopting new tools and techniques to create the next generation of digital production-printing systems that leverage and build on the success of prior printing and publishing systems.

One publishing area that has grown tremendously in recent years is the Publishing-On-Demand or Print-On-Demand (POD) industry. The POD marketplace continues to grow. Further, the world of publishing, a major source for digital pages, is currently undergoing change, including developing and adopting new business models. Although many changes are occurring in the industry, the publisher enforces centralized control over the end product and to date, open collaborative publishing systems and services do not exist in the marketplace.

Self-publishing efforts to date do not provide for a collaborative environment for the contribution of content. Also, readers cannot select specific materials for creating a custom work or volume from the content that is contributed. In addition, a collaborative environment wherein contributors can communicate with each other, via message services such as email and chat rooms and where such communication may be included in the publication, is needed. This would provide a social environment wherein the contributors may discuss the content of their contributions and create a system to selectively collaborate, communicate, publish and/or purchase works based upon the needs of the user. The disclosure detailed herein describes attempts to solve some or all of the problems listed above.

### SUMMARY

In one embodiment, a method of rendering a custom document includes providing a communication support module allowing for communications between a plurality of users. The method may also include storing content, such as e-mails, chat room discussions, blog entries, bulletin board entries, instant messages or other selected text and graphics, from the communications in a content repository. The method may include receiving a request via a search engine or other portion of a publishing services module to retrieve selected content items from the repository, It may also include assembling the selected content items in a structured document for publishing via a rendering device. The method may also include comprising converting the structured document to a file format that is suitable for rendering by a printing device.

The communication support module may be provided via a first interactive electronic portal, and the publishing services module may be provided via a second interactive electronic portal. Alternatively, both modules may be provided by the same portal. The method may also include tagging and categorizing the stored content. The assembling may include creating a structured document containing the selected content items arranged according to a document style and layout. The document style and layout selection may be based on an amount or type of the selected content items and a document genre, and it may be tailored to one or more features of the multifunction printing device or other rendering device.

In an alternate embodiment, a method of publishing a document includes maintaining a content repository of user contributions, where the user contributions include content created for publication, person to-person messages, and personal keepsakes. The method may include providing a interactive portal wherein a user may search the database and select contributions for publication. It may also include using an automated document layout manager to arrange the selected contributions for publication in a document on a rendering device, as well as publishing the document via the rendering device.

The content repository may categorize the contributions according to subject matter, attachments, groups, and organizations. The automated document layout manager may include templates that correspond to capabilities of the rendering device. The arranging may include selecting a document style and layout based on the selected contributions and a selected document genre. The arranging may also include creating a structured document that includes the selected contributions arranged in accordance with the selected document style and layout.

The publishing may include converting the structured document to a file format that is suitable for rendering by a printing device, and rendering the structured document on the printing device. The rendering device may be, for example, a multifunction printing device.

In an alternate embodiment, a personal publication system includes a collaborative publishing module that receives content from a plurality of users, tags the content based on one or more categories, and stores the tagged content in a content repository. The system may also include a publishing services module that contains: (i) a search engine that enables a user to access the content repository and select content from the repository for publication; (ii) an automated document layout manager that arranges the selected content into a structured document according to a selected document style; and (iii) a converter that converts the structured document into a format that is suitable for printing by a rendering device. The system may also include a communication support services module that receives communications from a plurality of users and determines whether, for each communication, the user who submitted the communication has permitted the communication to be received by the collaborative publishing module as content for the content repository.

### BRIEF DESCRIPTION OF THE DRAWINGS

FIG. 1 illustrates a block diagram of a system, which can be implemented in accordance with an embodiment.

FIG. 2 illustrates a block diagram of a system, which can be implemented in accordance with one embodiment.

FIG. 3 illustrates a block diagram depicting a collaborative document authoring and production system in accordance with an embodiment.

FIG. 4 illustrates a pictorial diagram of a system that can be implemented in accordance with one possible embodiment.

FIG. 5 is a process flow diagram of an exemplary document rendering system.

### DETAILED DESCRIPTION

Before the present methods, systems and materials are described, it is to be understood that this disclosure is not limited to the particular methodologies, systems and materials described, as these may vary. It is also to be understood that the terminology used in the description is for the purpose of describing the particular versions or embodiments only, and is not intended to limit the scope.

It must also be noted that as used herein and in the appended claims, the singular forms “a,” “an,” and “the” include plural references unless the context clearly dictates otherwise. Unless defined otherwise herein, all technical and scientific terms used herein have the same meanings as commonly understood by one of ordinary skill in the art. All publications mentioned herein are incorporated by reference. Nothing herein is to be construed as an admission that the invention is not entitled to antedate such disclosure by virtue of prior invention.

The particular values and configurations discussed in these non-limiting examples can be varied and are cited merely to illustrate embodiments and are not intended to limit the scope of the invention.

The term “module” as utilized herein may refer to a “software module.” Embodiments can be implemented in the context of modules. In the computer programming arts, a module may be typically implemented as a collection of routines and data structures that performs particular tasks or implements a particular abstract data type. Modules generally may be composed of one or more parts. For example, a software module may include the constants, data types, variables, and routines that may be accessed by other modules or routines. In addition, a software module may be configured as an implementation, which may be private (i.e, accessible perhaps only to the module), and that contains the source code or object code that actually implements the routines or subroutines upon which the module is based. Such modules may be utilized separately or together to form a program product that may be implemented through signal-bearing media, including transmission media and recordable media. In addition, as utilized herein, the term “search engine” refers generally to a computer program or software module that searches for specific documents or data via the use of “keywords”, categories, drop-down menus, and/or users and then returns a list or other representation of documents or data where the keywords, categories, menu items, and/or users were found. Furthermore, the term “tagging”, as utilized herein, may refer to using an identifier that helps to identify or classify information, such as a data header, metadata, HTML tag, or other device or method. Finally, the term “categorizing”, as utilized herein, may refer to grouping of information that has been tagged or otherwise identified.

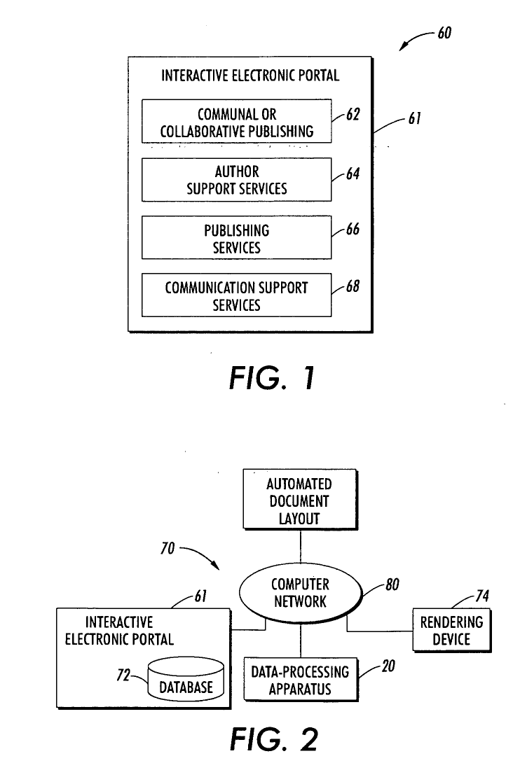

FIG. 1 illustrates a block diagram of a system 60, which may be implemented in accordance with an embodiment. System 60 generally includes an interactive electronic portal (e.g., a web portal) 61, which is configured to allow individual users, which may include authors or other individuals, to contribute content to a collection of materials for subsequent selection and inclusion in a printed bound volume. Any number of users can contribute content utilizing such an interactive electronic portal for reuse, while any number of readers or other users can select from available content for print utilizing such an electronic portal. Various content management tools can be provided via the electronic portal to assist in the selection of content from a larger collection to create a personalized volume.

Active participants can interact with services that support their active participation in the publications life cycle. Access to these services could be provided using web based information technologies. By implementing such an electronic portal, a publication no longer merely represents a fixed volume, but is the result of a dynamic interaction with a set of supporting services.

Such an electronic portal 61 can be implemented as an open publishing system that includes opportunities for communal publishing projects, author support services, and/or consumer support services. In addition, the electronic portal offers communication support services 68 such as, but not limited to, email, chat rooms, instant messaging, file sharing or social networking. To accomplish such tasks, a plurality of collaborative authoring, communication, and publishing services may be provided in the form of software modules, including an authoring tool module 64, a module providing a portal area for collaborative authoring 62, a publishing module 66 implementing a portal area providing publishing and consumer support thereof, and a communication module 68 providing a portal area to support communications between users of the electronic portal.

Collaborative authoring module 62, for example, may provide communal publishing projects (i.e., anyone can be a publisher) that can be facilitated via the electronic portal and may include, for example, administrative account services, tools for creating and managing collaborative publishing projects, support for collection and management of material, defining and selecting publishing project templates, and/or author and customer relationship management services. Author support services (i.e., anyone can be an author) may also be provided via authoring tool module 64 and may include, for example, author account services, interactive editorial services, easy contribution of content, content management services, and/or royalty payments for reuse. Customer support services (i.e., anyone can be a customer) may also be implemented via a publishing module 66 to include, for example, customer account services, an electronic “storefront”, content browsing and selection, defining and ordering a custom volume, and/or fulfillment services. Communication support services may be provided via a communication support tool 68, which may allow for communications between users of the electronic portal.

In addition, a user may access the communication tool 68 of FIG. 1 to communicate with other users about topics of particular interest. Groups with specific interests in common may create chat rooms, blogs, bulletin boards, instant message groups, file sharing, social networking or other features that would allow individuals within that group to communicate with one other. In addition, email may serve as communication for general interests and questions or may facilitate the formation of chat rooms.

Before a user enters a communication into the system using the communication support tool 68, the tool may require the individual to state whether contribution of the communication to a content repository is desired. If the individual does not choose whether to submit the communication, a default setting may be used that would automatically deposit the communication in the content repository. One or more content management tools may also be used to categorize and tag the communications for easier identification during the use of searching. For instance, an individual communication may be tagged and/or categorized according to subject matter, attachments, groups, and organizations. For example, if users of the tool were communicating about a particular event, such as a sports, academic, or social event, communications may be tagged and then the events may be categorized. The communication tool may also allow for exchange and publication of pictures, video files, audio files, text files, or other data. The individual may attach the picture or other file to the e-mail or otherwise load the picture onto the system so that the recipient and other users of the portal may retrieve the picture from the content repository and possibly include it in their publication. The communication support tool 68 may utilize the same user interface or interactive electronic portal 60 as the publishing services module 66, as illustrated in FIG. 1. Alternatively, separate user interfaces could be utilized. For example, the user interface utilized for the communication support tool 68 may be the user's personal e-mail or another communication system, and it could be separate from the portal 60 that is used for the publishing services module.

FIG. 2 illustrates a block diagram of a system 70, which may be implemented in accordance with one embodiment. System 70 includes computer network 80. A user can access the interactive electronic portal 61 via computer network 80. The interactive electronic portal 61 hosts or is in communication with a database 72, which may maintain a content repository of stored creative content contributed by users via the modules described above. The portal 61 may provide a window so that any communications tool such as a collaborative authoring tool, social networking tool, or other tool. The content repository database 72 may contain content intended for publication, such as photos or articles, and it may contain personal or general communications such as emails, instant messages, attached files, personal keepsakes (such as a diary entries, personal notes, awards, reports, memos) or other items. For a collaborative publication, such as a high school yearbook, students may be requested by a school representative, or document administrator, to contribute content to the database by utilizing a section or feature of the electronic portal that provides author relationship and account management tools. Student contributions may include, but are not limited to, communications, pictures, music, and/or projects.

The author support module 64 may provide students or other individuals with a set of tools to contribute content to the content repository. In such a scenario, in an embodiment a school representative may review the student' content for approval before it is made accessible to students/users online. In this scenario, the representative's role is focused on the collection and vetting of content for reuse. A student may be given the option of allowing all or a select number of students/users to have access to his or her contribution.

The collaborative authoring and publishing support module 62 may provide students or other individuals with a set of tools for collecting the contributions and arranging them for publication. Arrangement of the contributions for publication may be facilitated via selection and use of publication templates that may also be provided by the support service.

The collaborative authoring module 62 and/or author support module 64 may receive information from the user that assists in categorization of the data in the content repository. For example, an e-mail message may include a “from” line, a “to” line, a “subject” line, text, and one or more attachments. The modules 62 and 64 may analyze this information and tag or categorize it based on its association with the sender, the recipient, any groups to which the sender and/or recipient are known to belong, one or more keywords in the attachment, file attachment type (photo, text, etc.), or other classifying information. The tags may also include an indication of whether the author desires the information to be available to all users, a select group of users, or no users. Some or all of this information may be provided by the author, or it may be automatically generated through any suitable text recognition and parsing or other methods.

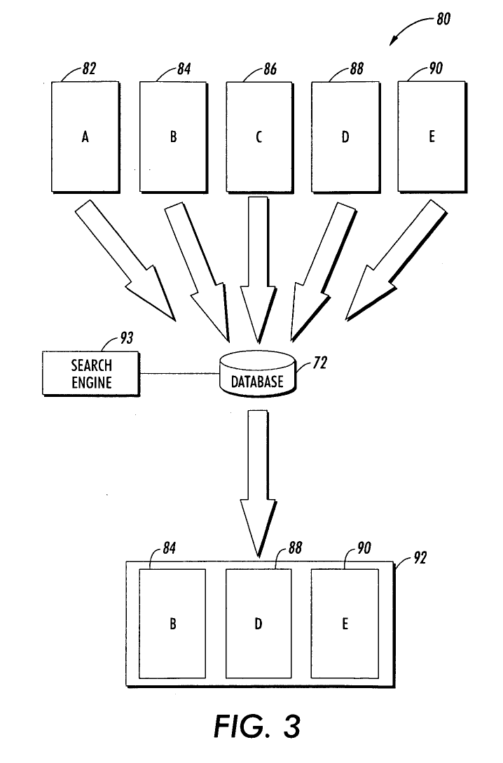

As an example of the services available through publishing services module 66, consider the case where a student is a member of a particular group or organization and would like to view the contributions of all members of that group. In such a scenario, the student may visit the electronic portal and search for the information by asking for all available information that has been “tagged” as relating to one or more members of the group. After acquiring all of the information, the student may use the information to create a certain number of pages for the publication. The student may then search for contributions submitted by his or her friends and, after acquiring that information, the student may use the information to create more pages for the publication An example is given in FIG. 3, wherein the student would utilize the search engine 93 to search the database 72 and review contributions responsive to search engine requests, such as photos 82, articles 84, person-to-person messages 86, clip art 88, and/or group member lists 90, needed to create a publication 92 out of a subset of the available contributions. Once the student created the publication, he or she thereafter can submit an order for a printed, and optionally bound, volume. The publishing services module 66 may assemble the content into a structured document for rendering as a printed volume on a rendering device such as a multifunction printing device.

Thus, any user may communicate with computer network 80 utilizing data-processing apparatus 20 and may access interactive electronic portal 61 and create and author his or her work for storage at database 72 (i.e., a repository). Note that database 72 may also be utilized in the context of Content Management Systems (CMS), Digital Asset Manager (DAM), XML Databases, and so forth. In addition, the computer network may be in communication with to one database, or multiple databases may be available via the computer network, with the available content being distributed among the available databases.

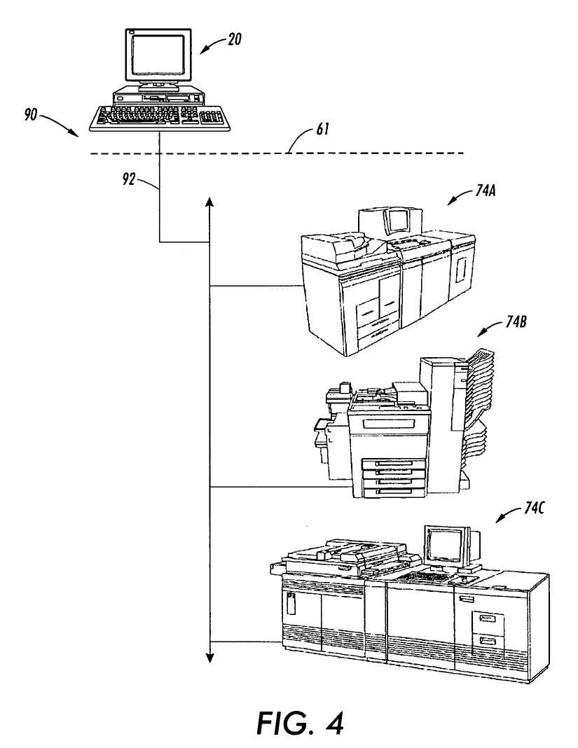

The publication or volume 92 may be rendered via one or more rendering devices 74A, 74B, and 74C depicted in FIG. 4. One example of a rendering device is disclosed in U.S. Pat. No. 6,844,937, “Digital Printing Apparatus with Remotely Selectable Operating Speeds and Features,” the disclosure of which is incorporated herein by reference. In addition, the computer network system 80 of FIG. 2 may provide an automatic document layout system, which in some embodiments may be tailored to specific rendering device capabilities. An automatic document layout system may provide the user with a layout of the document, as it would appear if it were published. Optionally, the automatic document layout system may provide the user with layout options that are tailored to the capabilities of the rendering device. For instance, an automatic document layout system connected to a laser printer that includes a choice of 256 colors may offer the user that same number of colors for his or her publication. Another example is an automatic document layout system that is tailored to a multifinction device that requires a one-inch binding margin on the left-hand side of each page of the publication that it prints. This layout system would provide the user with a layout of a document having a one-inch binding margin on its left-hand side.

One embodiment or prototype system may be implemented utilizing at least in part, for example, one or more existing solutions and services. One example of a commercial product, which may be adapted for use with the methods and systems indicated herein is the “DocuShare” product of Xerox Corporation. Such a product may be utilized to provide a Web-based, collaborative document and content management application for document intensive workgroups and may serve as a cornerstone in the implementation of a prototype environment.

Additionally, the DocuShare, Outlook and Explorer clients may be used to provide authors with a set of familiar MS-Windows based tools needed to contribute content. Publishers may take advantage of many of the native DocuShare features to manage authors, content, and associated business processes necessary to prepare content for dissemination. Such a prototype embodiment, may also be adapted to use applications such as, for example, Microsoft Office and extensible Markup Language (XML) capabilities. Office XML support would allow for the creation of XML schemas that may make an author's submissions self-describing facilitating the management and reuse. It can be appreciated that the use of such applications is described herein for illustrative and general edification purposes only and is not considered a limiting feature of the embodiments.

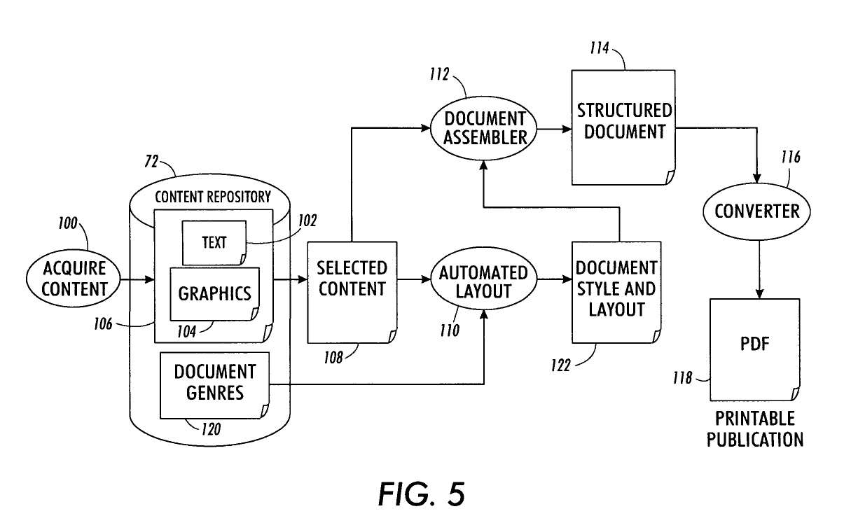

FIG. 5 is a process flow diagram that illustrates exemplary operations that may be performed by a custom publication rendering system. For example, the system may acquire content 100 from multiple sources, such as multiple individuals who are connected through an organization such as a school, church, business, trade organization or otherwise. The content may include text 102 and/or graphics 104, which optionally may be associated with each other as part of a document 106. The content may be stored in a content repository 72. When a user selects content 108 from the content repository for publication, the user may also select a document genre 120 such as a yearbook, pamphlet, magazine, or other publication type. An automated layout system 110, which optionally may be included in a collaborative authoring module or author support module, may select a document style and layout 122 based on the amount and/or type of selected content 108 as well as the selected document genre 120. A document assembler 112 may use the document style and layout to automatically assemble the selected content 108 into a structured document format 114 that is suitable for rendering. Optionally, the user may be permitted to modify the structured document by altering its format and/or adding or removing additional content. When the user is satisfied that the structured document is ready for printing, a converter or rendering engine 116 may convert the document to a file format 118 that is suitable for rendering or otherwise recognized by a printing device, such as a universal print format, portable document format, or other accepted format.

Although the description above relates to the use of the system in the context of a yearbook, it will be recognized that the system may also be used for publication of any personalized publication, such as a conference manual, club history, cookbook, or other item. In some embodiments, the rendering device may be available on-site at the event so that an attendee can select items for publication and have the final publication available before departing the event.

In various embodiments, interaction with the system may be via web-based access tools, the user's personal e-mail, or by another communication system. This allows for easier access to the system and reduces the time and costs involved with utilizing an interface that the user may not be as familiar with. In addition, in some embodiments the automated document layout system may provide the user with layout options that are tailored to the capabilities of a rendering device or multifunction device. This allows the user to take advantage of the capabilities of a specific device by implementing these capabilities into the user's document.

Accordingly, unlike prior collaborative systems, various embodiments of the systems and methods described herein may allow the creation of custom publications that include much more content than was previously available. Instead of merely providing a content repository of content that was created for the purpose of publication, the content repository contained herein may include ordinary, daily communications between individuals (such as e-mails, photos, blog entries, chat room entries, transcripts, presentations and other items) that were not specifically created for publication. Further, the content may be tagged and categorized for easy searching and identification according to criteria such as group affiliates, media types, content subject, or other appropriate criteria.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method of rendering a custom document, comprising:
providing a communication support module allowing for communications between a plurality of users;
storing content from the communications in a content repository;
receiving a request via a publishing services module to retrieve selected content items from the repository; and
assembling the selected content items in a structured document for publishing via a rendering device.

2. The method of claim 1 wherein:
the communication support module is provided via a first interactive electronic portal; and
the publishing services module is provided via a second interactive electronic portal.

3. The method of claim 1 further comprising tagging and categorizing the stored content.

4. The method of claim 1 wherein the request is received via a search engine.

5. The method of claim 1 wherein the assembling comprises creating a structured document containing the selected content items arranged according to a document style and layout.

6. The method of claim 4 further comprising selecting the document style and layout based on an amount or type of the selected content items and a document genre.

7. The method of claim 1 wherein the selected content items comprise data that is representative of text and graphics.

8. The method of claim 7 wherein the selected content items comprise e-mails, chat room discussions, blog entries, bulletin board entries, or instant messages.

9. The method of claim 1 further comprising converting the structured document to a file format that is suitable for rendering by a printing device.

10. The method of claim 9, wherein the document style and layout is tailored to one or more features of the rendering device.

11. The method of claim 1 wherein the rendering device comprises a multifunction printing device.

12. A method of publishing a document comprising:
maintaining a content repository of user contributions, the user contributions including content created for publication, person to-person messages, and personal keepsakes;
providing a interactive portal wherein a user may search the database and select contributions for publication;
arranging, via an automated document layout manager, the selected contributions for publication in a document on a rendering device; and
publishing the document via the rendering device.

13. The method of claim 12 wherein the content repository categorizes the contributions according to subject matter, attachments, groups, and organizations.

14. The method of claim 12 wherein the automated document layout manager includes templates that correspond to capabilities of the rendering device.

15. The method of claim 12 wherein the arranging includes selecting a document style and layout based on the selected contributions and a selected document genre.

16. The method of claim 15 wherein the arranging includes creating a structured document that includes the selected contributions arranged in accordance with the selected document style and layout.

17. The method of claim 12 wherein the publishing comprises:
converting the structured document to a file format that is suitable for rendering by a printing device; and
rendering the structured document on the printing device.

18. The method of claim 17 wherein the rendering device comprises a multifunction printing device.

19. A personal publication system, comprising:
a collaborative publishing module that receives content from a plurality of users, tags the content based on one or more categories, and stores the tagged content in a content repository; and
a publishing services module including:
a search engine that enables a user to access the content repository and select content from the repository for publication;
an automated document layout manager that arranges the selected content into a structured document according to a selected document style; and
a converter that converts the structured document into a format that is suitable for printing by a rendering device.

20. The system of claim 19 further comprising a communication support services module that receives communications from a plurality of users and determines whether, for each communication, the user who submitted the communication has permitted the communication to be received by the collaborative publishing module as content for the content repository.
